(19) United States
(12) Patent Application Publication
(10) Pub. No.: US 2010/0041262 A1
(43) Pub. Date: Feb. 18, 2010

(54) Energy Saving Switch of Continuously Powered Transformers

(76) Inventor: Suyanti Walujo Chesneau, Coppell, TX (US)

Correspondence Address: Suyanti Walujo Chesneau, 576 Parkway Blvd, Coppell, TX, 75019, US

(21) Appl. No.: 12/191,299

(22) Filed: Aug. 13, 2008

(51) Int. Cl. H01R 29/00

(52) U.S. Cl. 439/188

(57) ABSTRACT

An additional miniature switch or jumper switch to be integrated within the power connector of any device that is using transformer but that does not need to be connected to it all the time. The energy saving switch will disconnect the primary winding of the transformer from the voltage source when the device does not need to be powered.

The energy saving switch could also be integrated within the turn-on/off circuit of any devices that is using transformer continuously plugged to a voltage source to power the device that may be turned-off either with an interrupter (mechanical or even electronically with remote control).

The energy saving switch operates when a transformer is not in use but still wasting energy while connected to a voltage supply. The energy saving switch will simply disconnect the primary winding of the transformer when no device is connected or when the device is turned-off.

### FIELD OF THE INVENTION

The present invention relates to chargers, power supplies, rechargeable-power supplies and, particularly, to transformers.

### BACKGROUND OF THE INVENTION

One day my husband and I were watching a TV show that was talking about ways to save energy. One of them is to unplug unused devices (any kind that use transformer) from the outlet when not in use. It turns out that these transformers consume power whenever they are plugged into the wall outlets, whether they are connected to a device or not. Since then we try to unplug them when not in use.

One day I told my husband: “there should be an easier way than always having to bend down and unplug these transformers from the outlets! Why don't they put a switch inside the connector that will shut down the transformer when we disconnect the device?”. Hence, this idea begins.

The power consumption of an idle transformer is not large—on the order of 1 to 10 watts per transformer. But it does add up. Let's say that you have 10 transformers, and they consume 5 watts each. That means that 50 watts are being wasted constantly. For a year you will have wasted 50*24 hours 365 days=438 kilowatt-hour. A kilowatt-hour cost about 15 cents in my area, that means that I am wasting 438*0.15=$65.7 every year down the drain.

Going up to the scale of the US—there are roughly 100 million households in the United States. If each household wastes 50 watts on these transformers, that's a total of 5 billion watts. As a nation, that's more than $750,000 dollars wasted every hour, or $6,570,000,000 wasted every year! More than 6 billion dollars of energy are wasted in the US alone for a year.

Right now the only way to save energy when a transformer is not used is to disconnect the voltage source applied to its primary winding. Most of the time this means unplugging the device from the power outlet and this requires an effort from the user and his desire to save energy.

The shortcomings are that you need to have a person that is concerned about wasting energy and also that person is willing to unplug idle transformer each time.

It would be advantageous to provide a saving of energy by simply disconnecting the primary winding of a transformer of any unused device.

It would also be advantageous to provide a way for users not to change their habits but still make them save energy that would have been wasted other wise.

It would further be advantageous to provide an integrated switch directly to the power connector or within the turn-off circuit of the device.

### SUMMARY OF THE INVENTION

In accordance with the present invention, there is provided an additional miniature switch or jumper switch to be integrated within the power connector of any device that is using a transformer but does not need to be connected to it all the time. The energy saving switch will disconnect the primary winding of the transformer from the voltage source (usually the outlet) when the device is not being powered.

The energy saving switch could also be used with any device that is using transformer continuously plugged to a voltage source (any outlet for example) to power the device that may be turned-off either with an interrupter (mechanical or even electronically with remote control). The energy saving switch would be integrated within the turn-on/off circuit of the device and will disconnect the primary winding of the transformer from the voltage source when the device is turned-off.

The energy saving switch operates when a transformer is not in use but still wasting energy while connected to a voltage supply. The energy saving switch will simply disconnect the primary winding of the transformer when no device is connected or when the device is turned-off. This could be done even without notice from the user since he will be doing the same thing as before: unplugging the device from its power cord or turning it off.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a general flow chart interpretation of the energy saving method for any device or rechargeable power supply using a transformer;

FIG. 2 is a flow chart interpretation of the energy saving method for any device or rechargeable power supply connected by a removable power cord;

FIG. 3 is a schematic representation of an adapter or transformer that is always connected to a power supply;

FIG. 4 is a schematic of an adapter or transformer that could be disabled with a switch placed in series within the primary winding of the transformer;

FIG. 5 is a schematic of a typical rechargeable device or device that needs to be powered using an adapter that connects rechargeable-circuit to a power-supply via a power connectors;

FIG. 6 is a schematic of a power-saving technique of a rechargeable device or device that needs to be powered using an adapter that connects rechargeable-circuit to a power-supply via power connectors which contained a micro-switch or detect-switch within the female power connector; and

FIG. 7 is a schematic of a power-saving technique of a rechargeable device or device that needs to be powered using an adapter that connects rechargeable-circuit to a power-supply via power connectors which contained a jumper-switch within the male power connector.

For purposes of clarity and brevity, like elements and components will bear the same designations and numbering throughout the Figures.

### DESCRIPTION OF THE PREFERRED EMBODIMENT

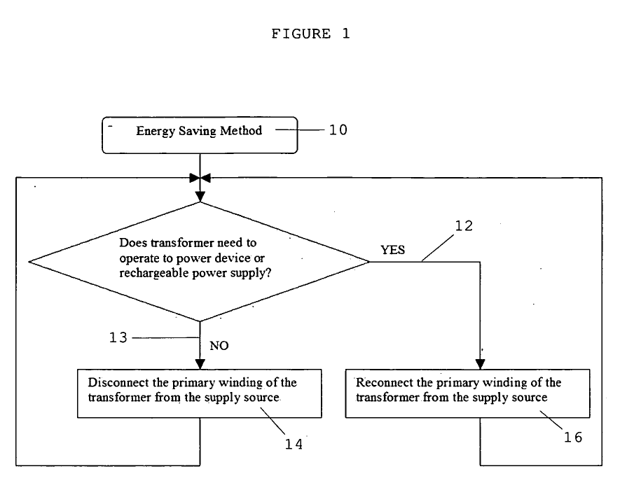

FIG. 1 is a general flow chart interpretation of the Energy saving method 10 for any device or rechargeable power supply using a transformer 32. It is determined whenever to detect that power is needed 12 to power the device or rechargeable power supply either when the power cord of the device is connected to the adapter for recharge-circuit or transformed power supply 38, or when the device is switched on manually or with remote control with the transformer 32 built-in within the device. It is determined whenever to detect that power is not needed 13 to power the device or rechargeable power supply either when the power cord of the device is disconnected from the the adapter for recharge-circuit or transformed power supply 38, or when the device is switched off manually or with remote control with the transformer 32 built-in within the device. If power is not needed to power the device or rechargeable power supply, a switch 42 will disconnect the primary winding of the transformer 14. If power is needed to power the device or rechargeable power supply, a switch 42 will reconnect the primary winding of the transformer 16.

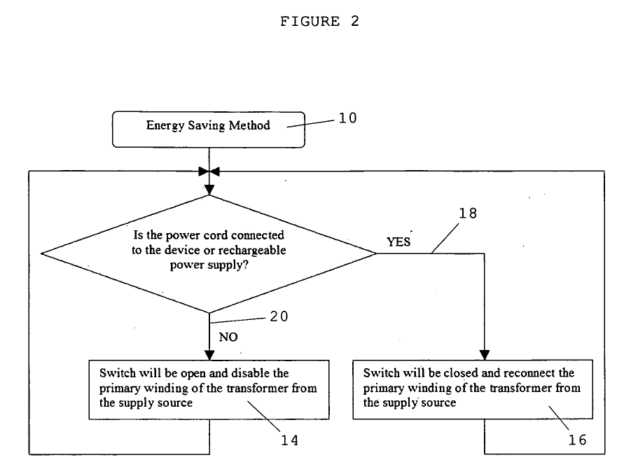

FIG. 2 is a chart interpretation of the Energy saving method 10 for any device or rechargeable power supply connected by a removable power cord to an adapter for recharge-circuit or transformed power supply 38. It is determined whenever the power cord is connected 18 to the device or rechargeable power supply. If the power cord is disconnected 20 to the device or rechargeable power supply, a switch 42 will disconnect the primary winding of the transformer 14. If the power cord is connected 18 to the device or rechargeable power supply, a switch 42 will reconnect the primary winding of the transformer 16.

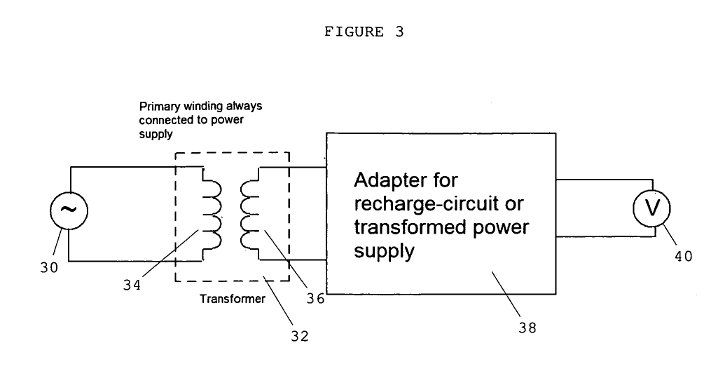

FIG. 3 is a schematic representation of an adapter including a transformer 32 that is always connected to a power supply. The transformer 32 is constituted of a primary winding of the transformer 34 and the secondary winding of the transformer 36. Here the power supply is an alternative power supply 30 that could be the alternative power supply 30 from the outlet 48. The primary winding of the transformer 34 is always connected to the power supply so it will always consume energy even if the adapter for recharge-circuit or transformed power supply 38 is connected to a device or not. Here the adapter for recharge-circuit or transformed power supply 38 will generate a voltage transformed 40 to power a device.

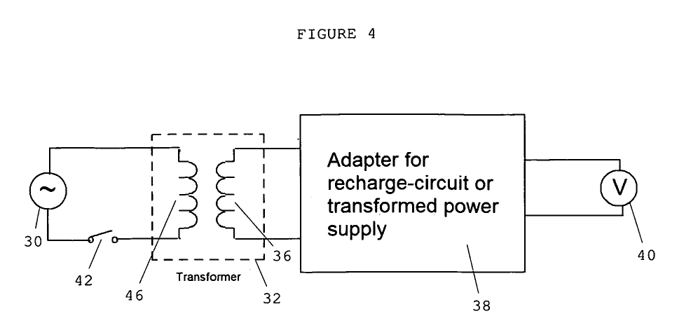

FIG. 4 is a schematic of an adapter or transformer 32 that could be disabled with a switch 42 placed in the primary winding of the transformer 34. In this case, the primary winding of the transformer in series with a switch 46 is not always connected to the power supply and could be disabled with the switch 42 if the adapter for recharge-circuit or transformed power supply 38 is not connected to a device via the power cord or does not need to operate because it is turned-off either manually or with remote control. The switch 42 could be integrated directly inside the power connector if the device uses a power cord to connect the adapter for recharge-circuit or transformed power supply 38. The switch 42 could also be integrated directly within the turn-on/off circuit of the device when the transformer 32 is within the device itself. If the device uses remote control to turn-on/off, an electronic switch 42 will be used to disconnect and reconnect the primary winding of the transformer 16. Since the main power supply will be disable the electronic switch 42 will need to be powered by a small battery that could be rechargeable.

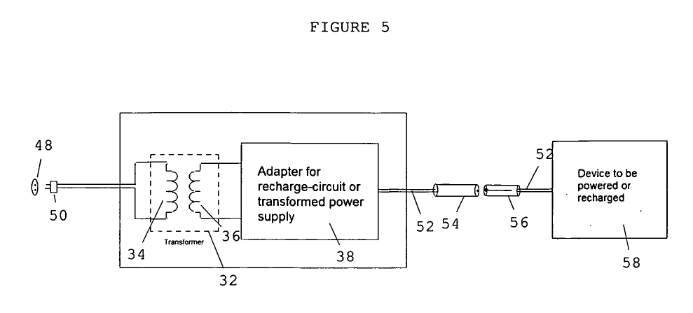

FIG. 5 is a schematic of a typical rechargeable device or device to be powered or recharged 58 using an adapter that connects rechargeable-circuit to a power-supply via power connectors (female power connector 54 and male power connector 56). Usually one female power connector 54 and one male power connector 56 are used to connect the adapter for recharge-circuit or transformed power supply 38 to the device to be powered or recharged 58. The primary winding of the transformer 34 is always connected to the outlet 48 via a power supply plug 50. Both the female power connector 54 and the male power connector 56 will need 2-wires conductor cable 52 to power or recharge the device to be powered or recharged 58.

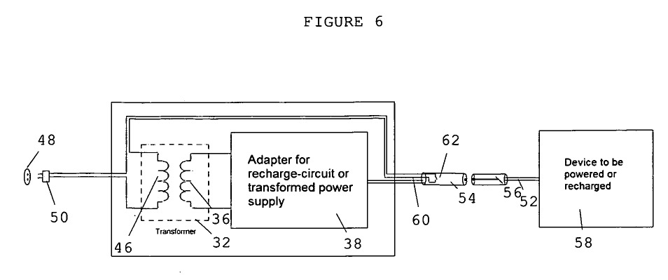

FIG. 6 is a schematic of a power-saving technique of a rechargeable device or device that needs to be powered using an adapter for recharge-circuit or transformed power supply 38 that connects device to be powered or recharged 58 to a power supply via power connectors which contained a micro-switch 42 or detect-switch within the female power connector 62. When the device to be powered or recharged 58 is connected via power connectors to the adapter, the detect-switch within the female power connector 62 will be closed and will reconnect the primary winding of the transformer 16, and the device will be powered. However when the device to be powered or recharged 58 is disconnected from the power connectors, the detect-switch within the female power connector 62 will be opened and will disconnect the primary winding of the transformer 14 and doing so will save energy when the device does not need to be powered or recharged. The female power connector 54 will require 4-wires conductor cable 60 instead of a 2-wires conductor cable 52 to be able to disconnect the primary winding of the transformer 14. The female power connector 54 will be a female power connector with 4 terminals 64. Two of the terminals will be used to connect the switch 42 and the others two will be used as usual to connect the transformed power supply.

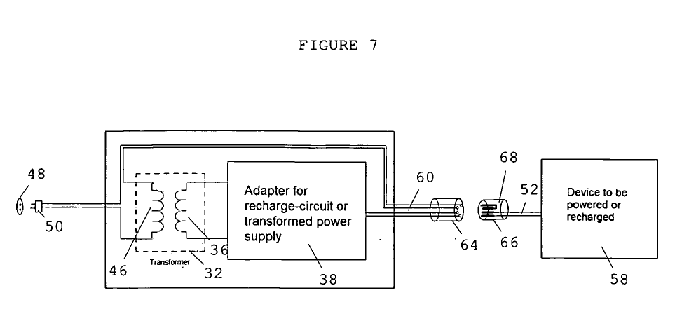

FIG. 7 is a schematic of a power-saving technique of a rechargeable device or device that needs to be powered using an adapter for recharge-circuit or transformed power supply 38 that connects device to be powered or recharged 58 to a power-supply via a power connector which contains a jumper-switch within the male power connector 68. When the device to be powered or recharged 58 is connected via power connectors to the adapter, the jumper-switch within the male power connector 68 will reconnect the primary winding of the transformer 16, and the device will be powered. However when the device to be powered or recharged 58 is disconnected from the power connectors, the jumper-switch within the male power connector 68 will disconnect the primary winding of the transformer 14, and by doing so will save energy since the primary winding of the transformer 34 will be disconnected from the power supply. The female power connector 54 will require 4-wires conductor cable 60 instead of a 2-wires conductor cable 52 to allow the primary winding of the transformer 34 to be disconnected from the power supply. The female power connector 54 will be a female power connector with 4 terminals 64. The male power connect will also require 4 terminals, but two of them will be shorted together to act as a jumper-switch within the male power connector 68. The male power connector 56 will be a male power connector with 4 terminals 66.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. An energy saving switch of continuously powered transformers for the purpose of the energy saving switch is to disconnect totally any transformer from the main voltage source when unused, comprising:
means for disconnecting the primary winding of the transformer from the supply source when the transformer is not needed to operate to power the device or the rechargeable power supply, or for reconnecting the primary winding of the transformer from the supply source when the transformer needs to operate to power the device or the rechargeable power supply.

2. The energy saving switch of continuously powered transformers in accordance with claim 1, wherein said means for disconnecting the primary winding of the transformer from the supply source when the transformer is not needed to operate to power the device or the rechargeable power supply, or for reconnecting the primary winding of the transformer from the supply source when the transformer needs to operate to power the device or the rechargeable power supply comprises a jumper switch within the male power connector, or detect-switch within the female power connector, or mechanical or electronic switch within the turn-on/off circuit of the device switch.

3. An energy saving switch of continuously powered transformers for the purpose of the energy saving switch is to disconnect totally any transformer from the main voltage source when unused, comprising:
a jumper switch within the male power connector, or detect-switch within the female power connector, or mechanical or electronic switch within the turn-on/off circuit of the device switch, for disconnecting the primary winding of the transformer from the supply source when the transformer is not needed to operate to power the device or the rechargeable power supply, or for reconnecting the primary winding of the transformer from the supply source when the transformer needs to operate to power the device or the rechargeable power supply.

4. An energy saving switch of continuously powered transformers for the purpose of the energy saving switch is to disconnect totally any transformer from the main voltage source when unused, comprising:
a device to be on, or power connectors to be connected to detect that power is needed, for detecting if the transformer needs to operate to power the device or a rechargeable power supply;
a device to be off, or power connectors to be disconnected to detect that power is not needed, for detecting if the transformer does not need to operate to power the device or a rechargeable power supply;
a switch, or jumper switch, or electronic switch to disconnect the primary winding of the transformer, for disconnecting the primary winding of the transformer from the supply source when the transformer is not needed to operate to power the device or the rechargeable power supply;
a switch, or jumper switch, or electronic switch to reconnect the primary winding of the transformer, for reconnecting the primary winding of the transformer from the supply source when the transformer is needed to operate to power the device or the rechargeable power supply;
a jumper switch within the male power connector, or detect-switch within the female power connector, or mechanical or electronic switch within the turn-on/off circuit of the device switch, for disconnecting the primary winding of the transformer from the supply source when the transformer is not needed to operate to power the device or the rechargeable power supply, or for reconnecting the primary winding of the transformer from the supply source when the transformer needs to operate to power the device or the rechargeable power supply;
a primary winding of the transformer in series with a switch, for the transformer to be enabled or to be disabled, safely wired to said switch;
a 4-wires conductor cable, for allowing the primary winding of the transformer to be disconnected or reconnected from the voltage source (in this case the outlet) and transmitting the transformed power supply to the device to be powered or recharged, safely wired to said switch;
a micro-switch, or push button switch or detect-switch within the female power connector, for detecting if the device is connected to the adapter for recharge-circuit or transformed power supply and for disconnecting or reconnecting the primary winding of the transformer from the power source with the detect-switch;
a female power connector with 4 terminals, for detecting if the device is connected to the adapter for recharge-circuit or transformed power supply and for disconnecting or reconnecting the primary winding of the transformer from the power source;
a male power connector with 4 terminals, for detecting if the device is connected to the adapter for recharge-circuit or transformed power supply and for disconnecting or reconnecting the primary winding of the transformer from the power source and integrating the jumper-switch; and
a jumper-switch within the male power connector, for detecting if the device is connected to the adapter for recharge-circuit or transformed power supply and for disconnecting or reconnecting the primary winding of the transformer from the power source with the jumper-switch.
